(19) United States
(12) Patent Application Publication
(10) Pub. No.: US 2013/0168905 A1
(43) Pub. Date: Jul. 4, 2013

(54) BORON-SILICON-CARBON CERAMIC MATERIALS AND METHOD OF MAKING

(71) Applicant: CoorsTek, Inc., Golden, CO (US)

(72) Inventors: Frank E. Anderson, Golden, CO (US); Kevin R. McNerney, Lakewood, CO (US); Steven M. Brazil, Benton, AR (US)

(73) Assignee: CoorsTek, Inc., Golden, CO (US)

(21) Appl. No.: 13/752,135

(22) Filed: Jan. 28, 2013

Related U.S. Application Data
(63) Continuation of application No. 11/538,409, filed on Oct. 3, 2006, now abandoned.
(60) Provisional application No. 60/753,106, filed on Dec. 22, 2005.

(51) Int. Cl. C04B 40/00

(52) U.S. Cl. CPC C04B 40/0089
USPC 264/643

(57) ABSTRACT

A reaction bonded ceramic body that has 50% to 60%, by weight, boron carbide, and 20% to 30%, by weight, silicon carbide. The reaction bonded ceramic body has least a portion of the boron carbide reacted with silicon to become siliconized boron carbide. Also, a method of making a reaction bonded ceramic material. The method may include the steps of forming a green body from a mixture of boron carbide, carbon, and an organic binder, and contacting the green body with a liquid infiltrant comprising silicon. The infiltrant has a temperature of about 1625° C. to about 1700° C. Furthermore, a method of making a reaction bonded boron carbide ceramic body. The method includes the steps of forming a green body from a mixture of boron carbide, carbon, and an organic binder. The weight ratio of boron carbide to carbon in the green body may be about 5:5 to 1 or more. The method also includes siliconizing a first portion of the boron carbide to siliconized boron carbide by contacting the green body with a molten silicon infiltrant, where the infiltrant has a temperature of about 1625° C. to about 1700° C. The method may further include dissolving a second portion of the boron carbide in the silicon infiltrant, where at least some of the dissolved boron carbide is reprecipated as smooth particulates.

### CROSS-REFERENCES TO RELATED APPLICATIONS

This application is a continuation of U.S. patent application Ser. No. 11/538,409, filed Oct. 3, 2006, which claims the benefit of U.S. Provisional Application No. 60/753,106 filed Dec. 22, 2005, entitled “BORON-SILICON-CARBON CERAMIC MATERIALS AND METHOD OF MAKING,” the entire contents of which are herein incorporated by this reference.

### FIELD OF THE INVENTION

This invention relates to tough, lightweight reaction-bonded boron and silicon carbide ceramic materials that can be used in various applications, including bullet and shrapnel resistant armor. The invention also relates to methods of making the ceramics, which includes reacting a portion of the boron carbon starting material with a molten silicon infiltrant.

### BACKGROUND OF THE INVENTION

Ceramic materials have augmented, and sometimes supplanted, metals and high strength fibers in armor applications for vehicles and personnel. Initial concerns that ceramics would be too inflexible and brittle to use in armor have given way to recognition that hard, lightweight ceramics have advantages over metal armor such as heavy gauge steel. Ceramics used in armor are generally less dense than metals like iron and steel, providing thicker armors for the same weight. This can be especially important for applications like body and aircraft armor where decreasing the armor's weight without compromising its ballistic stopping power is desirable.

One property that is shared by many good ceramic armors is high hardness. Armor should at least be as hard or harder than the projectile hitting the armor. This way, the armor can fracture and erode the impacting projectile before it can penetrate the bulk armor material. When the armor is made from a composite material of ceramic and metal, overall hardness is generally proportional to the volume fraction of the hard ceramics in the material. Thus harder armors can be made by loading the composite with a high volume fraction of hard ceramics.

One hard ceramic material used frequently in composite ceramic armor is silicon carbide. Hot pressed silicon carbide armor is typically two to three times harder than a bullet made of tool steel, and has been used in various body and vehicle armor applications. But techniques for hot pressing hard ceramics are difficult to control and expensive. Hot pressed ceramics can undergo inconsistent sintering that create significant variations in the dimensions in the final body. This can make the armor pieces difficult to form into the intended shape, especially as they get larger in size and have more complex shapes and curves. In some cases the rough pieces can be ground or machined to an adequate degree of conformity, but often the hardness of the material makes this so difficult as to be impractical on a commercial scale.

A less expensive and more consistent process for making ceramic armor involves reaction bonding between a green body of powdered ceramics and a molten metal infiltrant. For example, silicon can be melted or poured onto a green body of silicon carbide and carbon powder to form a reaction bonded silicon carbide (RBSC) armor piece. Historically, reaction bonded ceramic armors were considered to have inferior anti-ballistic performance to monolithic hot pressed armors, and reaction bonding techniques were disfavored despite their lower cost an more consistent production. But more recently, armor manufacturers have discovered that careful control of the starting materials and reaction conditions can produce reaction bonded ceramic armors with anti-ballistic properties equal or better than hot pressed armors.

One class of reaction bonded ceramic materials that have received a lot of recent attention is reaction bonded boron carbide (RBBC). These composite materials include boron carbide, silicon carbide and silicon that are made from reacting a silicon infiltrant with green bodies of boron carbide, carbon, and optionally, silicon carbide. Boron carbide is both harder and less dense than silicon carbide, making it the preferred ceramic in many armor applications, especially lightweight body armor. In RBBC fabrication processes, molten silicon infiltrant reacts with the carbon and boron carbide in a green body to form a reaction bonded composite of in-situ silicon carbide, boron carbide and silicon metal.

Armor manufacturers have made a number of assumptions about how RBBC fabrication processes should be controlled to produce reaction bonded armors comparable to hot pressed or sintered ceramic armors. Among them is the belief that the reaction between the silicon infiltrant and boron carbide should be minimized as much as possible. Underlying this belief is the fact that the reaction consumes a ceramic with higher hardness (i.e., boron carbide) to produce a ceramic with lower hardness (i.e., silicon carbide). The reaction can also produce silicon borides that have an even lower hardness. There has also been speculation that the exothermic nature of the reaction cause localized hot spots where oversized grains of silicon and boron carbide get formed. The large grains can weaken the intergranular bonding in the ceramic body and cause the armor to fracture more easily.

Acting on these assumptions, RBBC fabrication processes have been carefully controlled to minimize the reaction between the silicon infiltrant and boron carbide. This includes lowering the temperature of the silicon infiltrant to the low end of the reaction bonding range. This range extends from about 1450° C. (where silicon melts) up to about 2200° C. Currently, the preferred reaction bonding temperatures are 1450° C. to 1550° C., with temperatures above 1600° C. discouraged out of concern that too much silicon infiltrant reacts with the boron carbide.

Another way manufacturers minimize the reaction between silicon and boron carbide is to dissolve boron into the silicon infiltrant. The dissolved boron has been demonstrated to reduce the activity of the silicon for reacting with the boron carbide in the green body. In addition, the total amount of boron carbide reacted can be reduced by loading the green body with more carbon (e.g., graphite powders or organic resins). The goal is to produce more silicon carbide by reacting the molten silicon with free carbon than carbon from boron carbide. Still another approach is to preload the green body with significant amounts of pre-made silicon carbide and use less molten silicon to generate in-situ silicon carbide from carbon sources in the body. Manufacturers recognize that there is a tradeoff with these approaches because overloading the green body with too much carbon or silicon carbide results in a higher percentage of the softer silicon carbide compared to the harder boron carbide.

A closer examination has been made of some assumptions about fabricating high-quality RBBC armors. This included a critical look at the belief that the reaction of a silicon infiltrant with boron carbide should be suppressed to the greatest extent possible. The results from empirical tests and analysis have led to the conclusion that at least some reaction of the boron carbide is desirable for producing armors with high hardness and enhanced fracture toughness. The present invention includes new ceramic composite materials and methods of making the materials based on this conclusion.

### BRIEF SUMMARY OF THE INVENTION

Embodiments of the invention include a reaction bonded ceramic bodies. The bodies may have about 50% to about 60%, by weight, boron carbide, and about 20% to about 30%, by weight, silicon carbide. At least a portion of the boron carbide has reacted with silicon to become siliconized boron carbide.

Embodiments of the invention may also include methods of making a reaction bonded ceramic material. The methods may include the steps of forming a green body from a mixture of boron carbide, carbon, and an organic binder, and contacting the green body with a liquid infiltrant comprising silicon. The infiltrant may have a temperature of about 1625° C. to about 1700° C.

Embodiments of the invention may further include methods of making a reaction bonded boron carbide ceramic body. The methods may include the step of forming a green body from a mixture of boron carbide, carbon, and an organic binder. The weight ratio of boron carbide to carbon in the green body may be about 5:5 to 1 or more. The methods may also include siliconizing a first portion of the boron carbide to siliconized boron carbide by contacting the green body with a molten silicon infiltrant, where the infiltrant has a temperature of about 1625° C. to about 1700° C. In addition, the methods may include dissolving a second portion of the boron carbide in the silicon infiltrant, wherein at least some of the dissolved boron carbide is reprecipated as smooth particulates.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

FIG. 1 is a flowchart of a method of making a reaction bonded ceramic composite according to embodiments of the invention;

FIGS. 2A-G are electron microscope pictures of the surface of a RBBC ceramic bodies;

FIG. 3 is unit cell structure of boron carbide;

FIG. 4 are chemical formulas for some reaction pathways and equilibrium states for the reaction of silicon and boron carbide;

FIG. 5 is a X-Ray diffraction spectrum of a RBBC ceramic body made according to embodiments of the methods of the invention;

FIGS. 6A-E are additional X-Ray diffraction spectra of RBBC ceramic bodies;

FIGS. 7A-C include data on the physical properties of some RBBC ceramic bodies; and

FIG. 8 is a plot of temperature versus thermal linear expansion for silicon.

### DETAILED DESCRIPTION OF THE INVENTION

The present invention includes reaction bonded ceramic materials, and methods of making the materials, where a silicon infiltrant react with at least some boron carbide present in a green body or preform. The relative amounts of infiltrant, boron carbide, free carbon, and the reaction temperature used to make the composite may all be controlled to promote some reaction of the silicon and boron carbide. The resulting products have excellent hardness and surprisingly good fracture toughness that make them competitive with current industry standard hot pressed and reaction bonded ceramic armors.

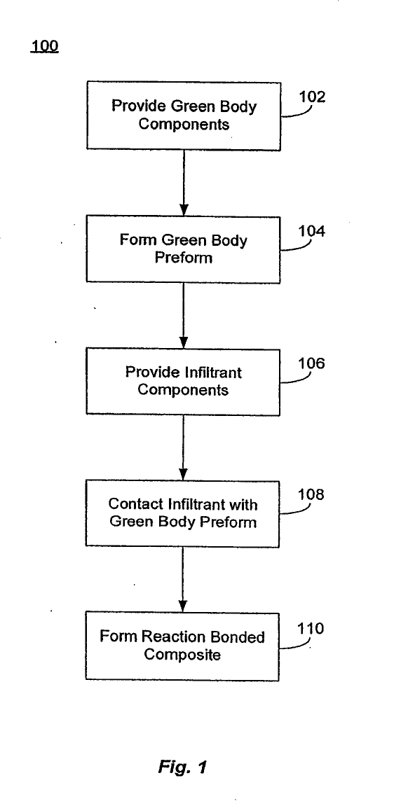

FIG. 1 shows steps in a method 100 for making reaction-bonded ceramic composites according to embodiments of the invention. The method includes forming a reaction bonded composite from a silicon containing infiltrant and boron carbide containing green body preform, so the final product will be referred to as reaction bonded boron carbide (RBBC). But the reaction bonding process also forms in-situ silicon carbide, and additional silicon carbide may also be added to the green body, so the end product can also be considered reaction bonded silicon carbide (RBSC). For purposes of the discussion here, RBBC materials may be considered a type of RBSC materials that include boron carbide in the green body preform.

The method 100 includes providing the components that make the green body 102 to which the molten infiltrant is added. These components may include granular boron carbide and particulate carbon (e.g., carbon black, graphite), as well as carbon resins that may act as a binder. In some embodiments, silicon carbide may also be a component.

Examples of commercially available boron carbide that may be used in the green body include TETRABOR® B₄C (ESK of Kempten, Germany). When silicon carbide is used in the green body, it may come from a commercial source, such as CRYSTOLON SiC (Saint-Gobain/Norton Industrial Ceramics of Worcester, Mass.). Grain sizes for the ceramics may be on the order of 10² μm to 10¹ μm, with a typical size range from about 200 μm to about 40 μm. In some embodiments, the grain size distribution may be narrowed by sieving the ceramic particles through an appropriate sized screen. For example, a 170 mesh screen may be used to filter out grains larger than 90 μM.

Green body compositions may include weight ratios of boron carbide to free carbon from about 5:1 to about 6:1. For example, one starting green body composition included 85%, by wt., boron carbide mixed with 15%, by wt., of granular carbon and a carbon binder. When granular silicon carbide is added, it typically is added up to about 30%, by wt., of the green body (e.g., about 10% to about 30%, by wt.). The silicon carbide may disproportionately replace the boron carbide and/or free carbon to skew the weight ratio of boron carbide to free carbon in the final green body composition.

Once the green body components are selected, they may be formed into a green body preform 104 that receives the infiltrant. Making the preform may include mixing the powdered components into a substantially homogeneous mass. A binder made from carbon based resins or syrups, such as starches, sugars (e.g., fructose, sucrose, etc.) may be added to bind and clump the powdered components. The mass may then be poured or pressed into a mold to cast the material into a desired shape. The material may be frozen into a self-supporting preform and removed from the mold. The frozen preform may then be placed into a low-oxygen furnace that heats the preform to a temperature at which the carbon binder is pyrolyzed to form a bonded preform.

The method 100 also includes preparing an infiltrant that will contact and react with the components of the preform. This may include providing the components of the infiltrant 106, such as silicon metal. It may also include materials such as boron (e.g., elemental boron, boron carbide, etc.) that allows the infiltrant to soak more uniformly into the green body, and regulate the extent of the reaction between the silicon in the infiltrant and boron carbide in the green body. When no boron is added to the silicon, the molten infiltrant tends to penetrate the surface of the green body unevenly to create unwanted dimples and pits on the surface of the finished product. But when too much boron is added, it interferes with the reaction between the silicon and boron carbide in the green body. The boron concentration in the infiltrant may be high enough to allow more uniform soaking of the infiltrant into the green body, but not so high to prevent the silicon from reacting with boron carbide.

With the infiltrant materials provided, the molten infiltrant may be contacted with the green body preform 108. Embodiments include distributing the infiltrant materials as solid powders on one or more surfaces of the green body and melting the infiltrant into the green body. A carbon cloth may be placed between the green body surface and infiltrant to help distribute the molten infiltrant more evenly on the surface.

The molten infiltrant is heated at about 1625° C. to about 1700° C. during infiltration and reaction bonding with the components of the green body. There is evidence that the molten infiltrant dissolves at least some of the boron carbide in the green body at these temperatures. Boron carbide may be precipitated from the infiltrant phase as the reaction bonded product cools. At least a portion of the dissolved boron carbide may react with the liquid silicon to form siliconized boron carbide that also precipitates from the infiltrant cools.

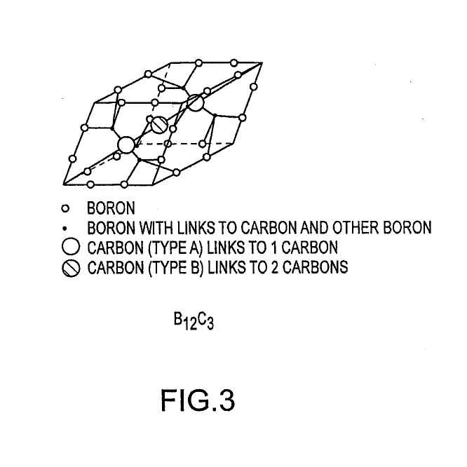

Precise characterization of the empirical formulas and crystal structures of the siliconized boron carbide products is difficult. Boron carbide is usually described using the normalized empirical formula B₄C, but a formula that more accurately reflects its icosahedral unit cell structure is believed to be B₁₂C₃ (see FIG. 3). The boron carbide icosahedra structures are believed to form even larger clusters in the solid state, including a rhombohedral structure that have the icosahedral structures residing at the corners of the rhombohedra. A three carbon intericosahedral chain may be formed between the icosahedra. Additional details about the structure and thermodynamics of solid state boron carbide crystal structures are described in a paper by David Emin titled “Structure and Single-Phase Regime of Boron Carbides” published Sep. 15, 1988, in Physical Review B (vol. 38, no. 9, pp. 6041-6055), the entire contents of which is hereby incorporated by reference for all purposes.

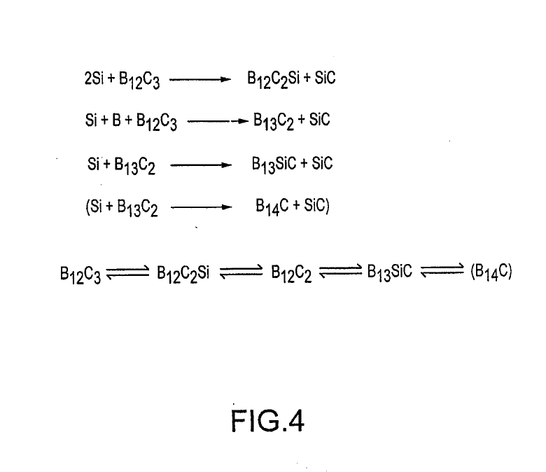

FIG. 4 shows some possible reaction pathways for the reaction of silicon with boron carbide. When the boron carbide reacts with silicon, the reaction paths may include substituting one or more of the carbon atoms in the carbon chain with silicon atoms. The silicon atom substitution may increase the stability of the unit cell structure and make it less likely to fall apart after receiving a strong jolt of kinetic energy, such as when a bullet impacts an armor plate made from the material. Thus, having silicon infiltrant react with some of the boron carbide in the green body may enhance the ability of the reaction bonded armor to withstand impacts from shrapnel, bullets and explosions.

Another reaction that occurs during reaction bonding produces in-situ silicon carbide from the silicon infiltrant and free carbon. At infiltration temperatures, the free carbon is very reactive with the silicon, and it's assumed all the carbon is converted to silicon carbide. In-situ silicon carbide made from the molten silicon and free carbon has a different phase (the β-form) than most commercially available grades of silicon carbide (the α-form). Embodiments of the reaction bonded composites include both the β-form of silicon carbide generated in-situ during the reaction bonding and the α-form from silicon carbide added to the green body preform. Additional embodiments where no silicon carbide was used in the green body, the reaction bonded composite mostly contains the β-form of silicon carbide.

The amount of infiltrant provided to the green body may depend on the amount of silicon needed to react with the free carbon and at least a portion of the boron carbide in the green body, as well as additional silicon needed to fill the pores and other intersticies in the preform. In armor applications, there is a tradeoff between having too much or too little silicon metal in the reaction boded product. Too much silicon metal reduces hardness, which degrades the ability of the armor body to fracture and erode the impacting projectile before it hits the bulk of the armor. Too little silicon metal makes the armor body more brittle (i.e., reduces its fracture toughness) making it easier to drive a crack (and a projectile) through the armor body. Reaction bonded materials of the present invention may have a silicon metal content of about 10% to about 20% by weight. The total amount of infiltrant starting materials used may exceed the estimated minimum by 5%, 10%, 15%, etc., (by wt.) or more.

Oxygen in the air can react with the molten silicon in the infiltrant, so the infiltration may be done at low pressure reduce the level of free oxygen present. For example, a mechanical roughing pump may be used to reduce the pressure in the reaction bonding furnace to about 100 millitorr or less. Embodiments also include displacement of the air in the furnace with an inert gas such as helium, argon, etc.

As the infiltrant soaks into and reacts with the green body, the reaction bonded composite is formed 110. The reaction bonded composite may be cooled and removed from the heating chamber. In large batch production of reaction bonded armor plates, a random sampling of the plate may be done to assure that the batch meets requisite quality levels.

### Experimental

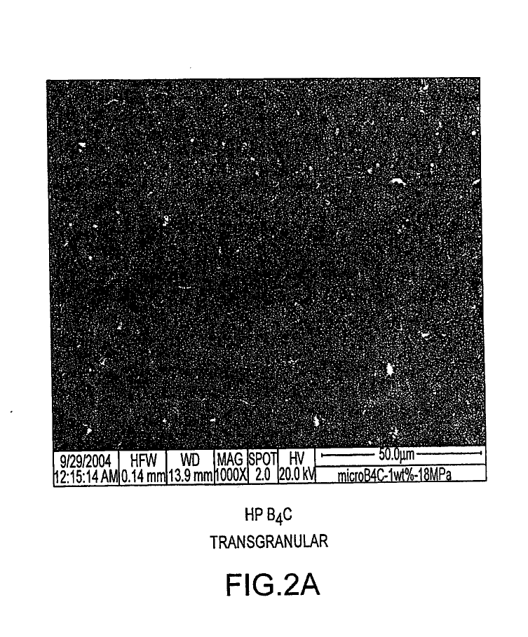

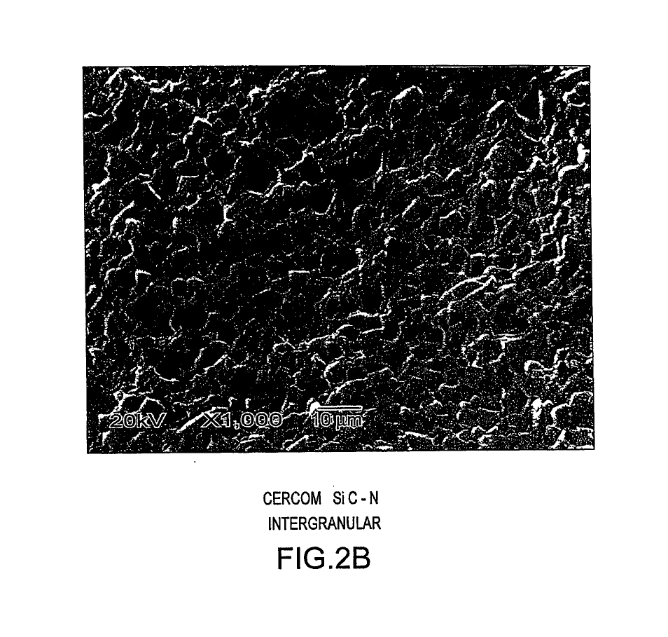

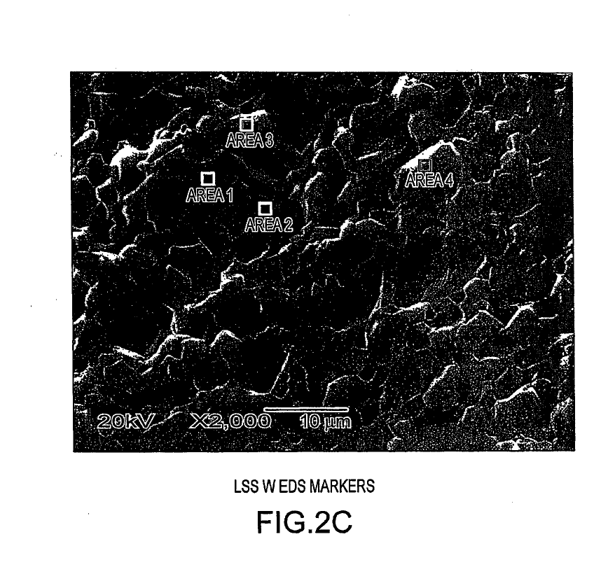

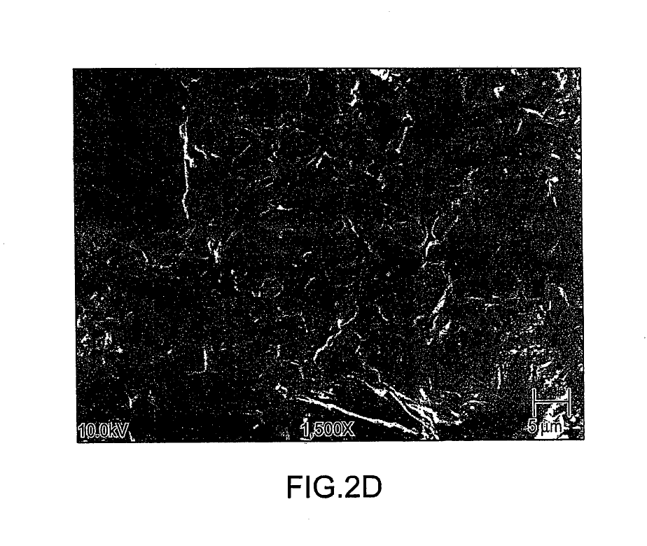

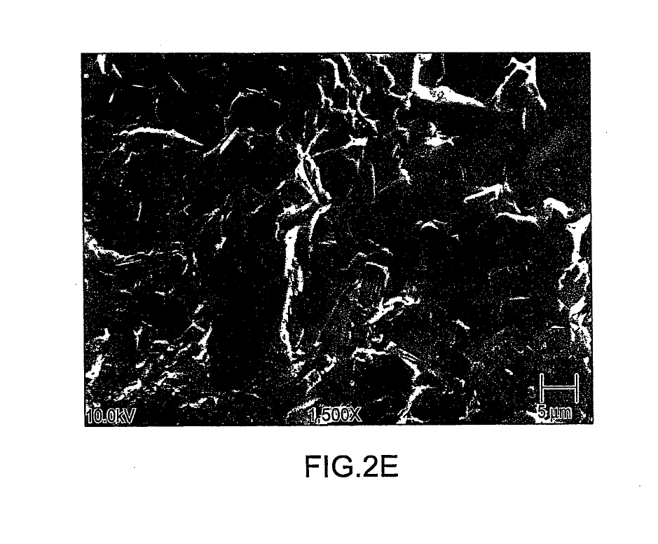

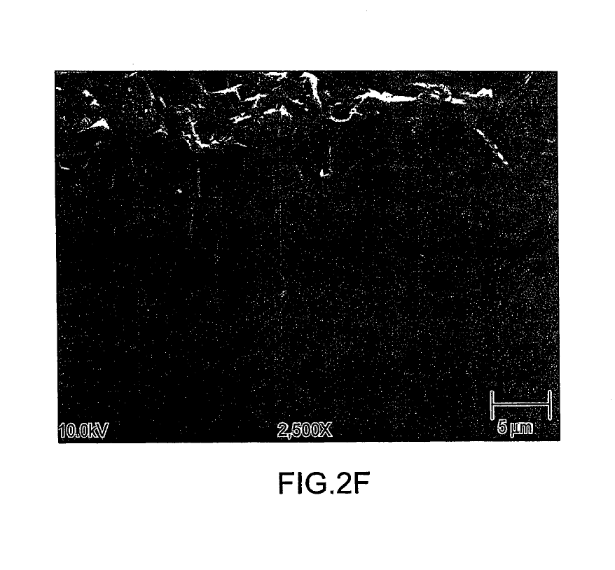

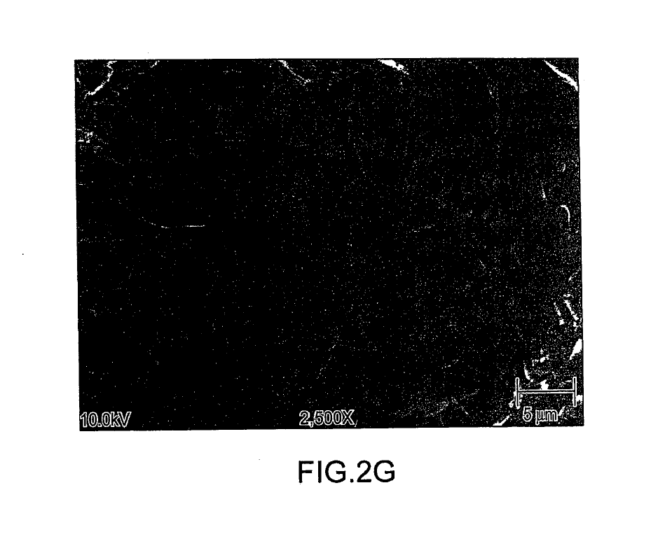

FIGS. 2A-G show electron micrographs of reaction bonded boron carbide body armors. The smooth-edged morphology seen in some of these pictures (e.g., FIG. 2B) indicates that at least some of the boron carbide from the green body has been dissolved in the silicon infiltrant and then reprecipitated. Evidence of needle shaped structures of silicon carbide are also observed in some of the scans (e.g., FIGS. 2F and 2G).

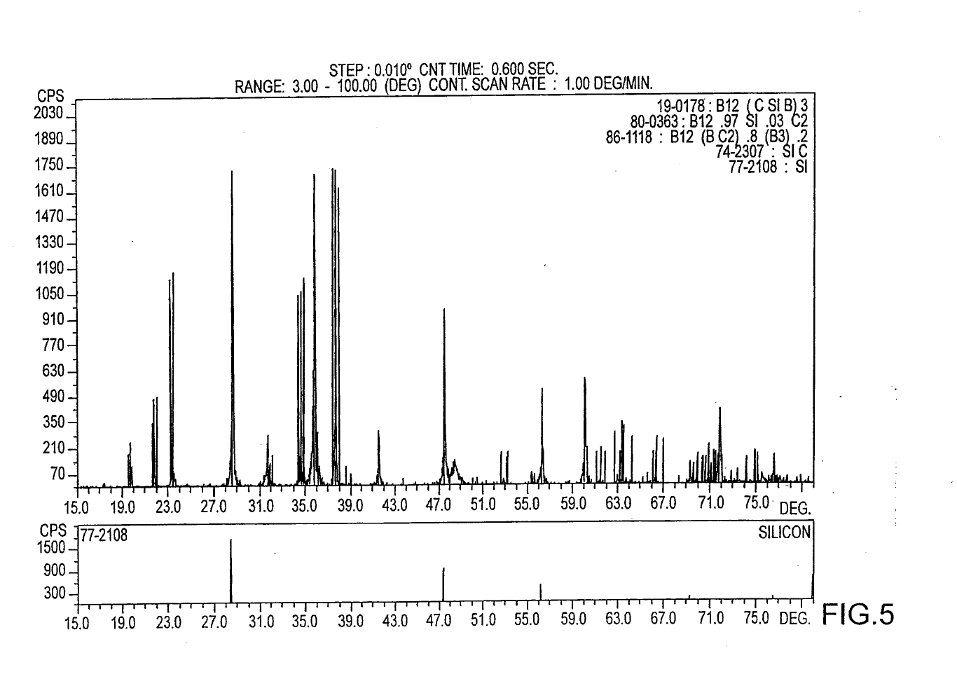

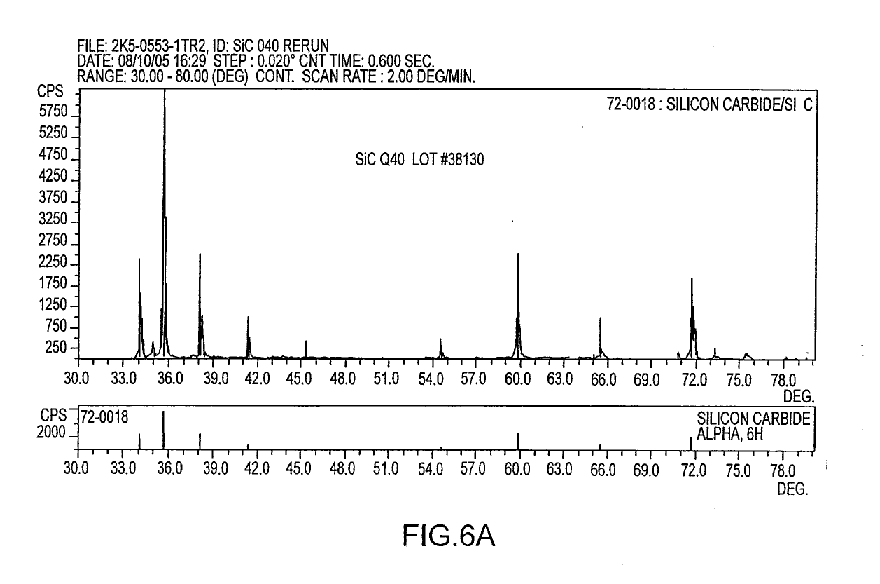

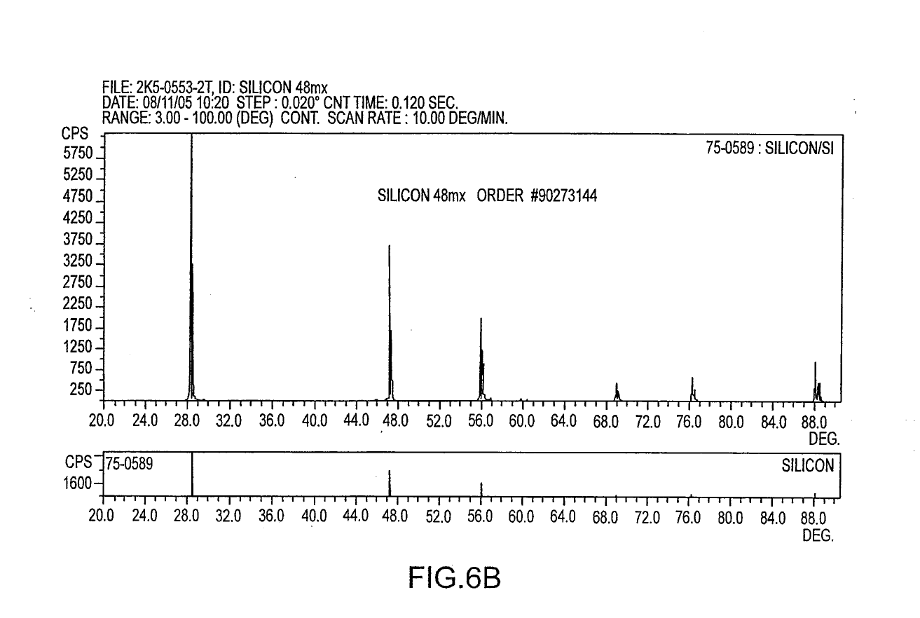

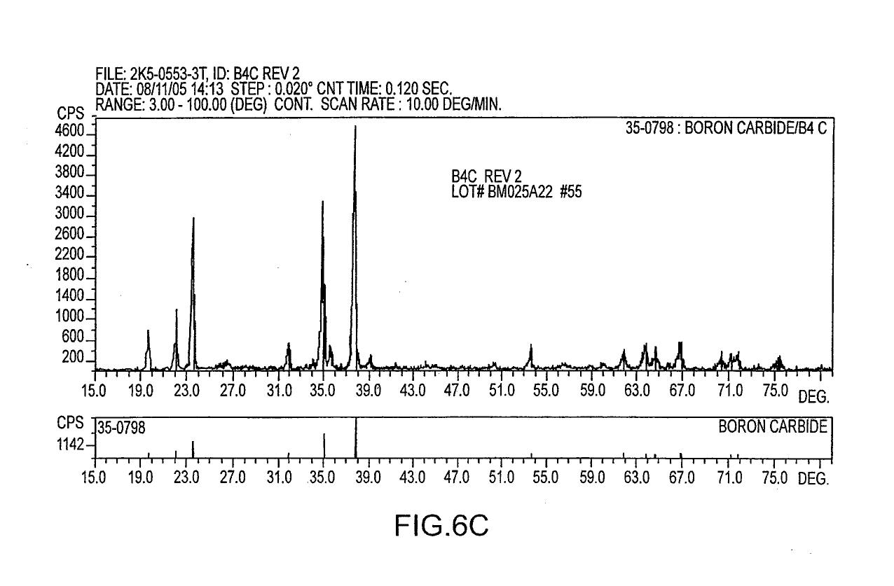

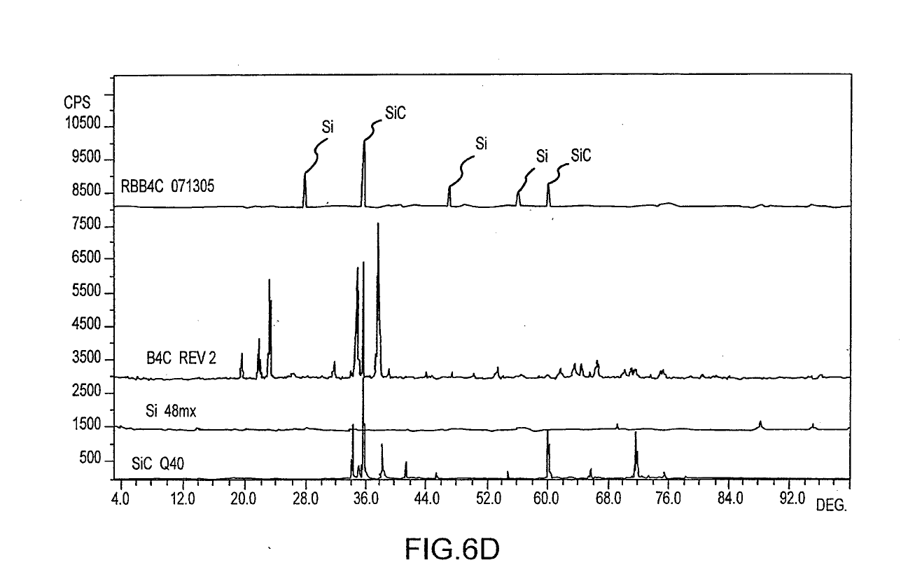

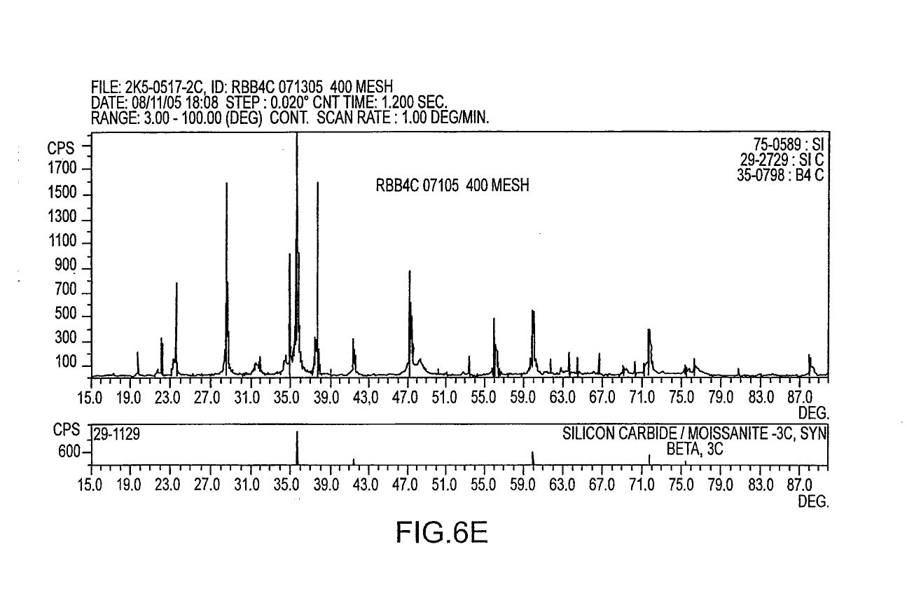

FIG. 5 and FIGS. 6A-E show X-Ray Diffraction spectra of RBBC armors made according to embodiments of the invention. XRD was used to quantitatively determine the amount of each phase of silicon carbide, silicon metal and boron carbide in sample parts of the RBBC body.

The standards used were relatively pure raw materials. The sample and standards were ground to a fine powder to 400 mesh. An X-ray diffractogram was obtained using a Scintag Pad X theta-theta diffractometer under the following analytical conditions: Copper tube operated at 45 kV, 40 MA; goniometer radius 250 mm; slits used were 6, 1, 0.5 and 0.3 mm; germanium solid state detector bias 1000 V; PHA set to accept only Cu K-alpha radiation; scan speed 1.0 degree 2-theta per minute; chopper increment 0.02 degrees 2-theta; scan range 3 to 100 degrees 2-theta; the samples and standards were mounted in a 1″ sample holder. The phases were identified by comparing the diffractogram of the sample to standard patterns in the International Centre of Diffraction Data (ICDD) database.

Each material was scanned at least twice to determine its peak intensity repeatability. The silicon carbide standard exhibited a tendency for preferred orientation, which alters the peak intensities. This would definitely have a profound effect on the quantitative determination. Changes in the sample mounting technique resulted in fair repeatability. FIG. 6A shows one of these scans with the ICDD stick pattern overlapped on the sample pattern for verification. The standard is an alpha silicon carbide with the 6H crystal structure.

The silicon standard materials showed the best repeatability. FIG. 6B shows the standard scan with the ICDD stick pattern. The boron carbide standard showed good repeatability and is shown in FIG. 6C. FIG. 6D shows the three standard materials overlapped and repositioned for comparison. Also a good representative scan of the ground sample is also present. The major peaks for the silicon carbide and silicon standards do not overlap and exhibit good intensities, which helps achieve good results in the quantitative procedure. However, the boron carbide major peak is small and may overlap with another boron carbide phase peak that appears in the sample.

FIG. 6E has the ICDD stick patterns for the various phases found in the sample scan. Silicon metal appears in the ground sample pattern. The major peak is free of other phase overlap and repeats well. Quantification of this phase should have good results.

The silicon carbide phase in the sample is the beta 3C polytype, not the alpha 6C polytype found in the standard. The differences between the major peak intensities of the two polytypes is unknown. If the relative intensities are close then the quantified value should be good. There is peak overlap from a secondary boron carbide peak, but the effect should be of little consequence.

The boron carbide phase is more complicated. First, the remaining phase in the sample is not just the boron carbide (B₄C) phase as found in the standard. There is clearly another phase, which is a good match for siliconized boron carbide (e.g., B₁₂(CSiB)₃). The effect of this phase has a peak that overlaps the major boron carbide peak.

The standard used in the quantification was made by mixing the supplied raw materials in the following phase weight percentages: 60.0% B₄C; 30.0% SiC; 10.0% Si. The sample and standard were scanned under the same analytical parameters and duplicate runs were incorporated in the calculations. The relative peak area of the major peak for each phase were calculated using the profile fitting software. The sample phase percentages were calculated using direct relative peak ratios with the standard. The calculated phase percentages, by wt., for the sample were: 9.3% B₄C; 22.5% SiC; and 10.9% Si.

### Mechanical and Physical Properties of the Reaction Bonded Plates

Various mechanical and physical properties of the reaction-bonded ceramic bodies may be tested. These may include density (e.g., in units of kg/m³), Young's Modulus (e.g., GPa), Flexural Strength (e.g., MPa), and Fracture Toughness (e.g., MPa-m^{1/2}), among other properties. Density may be measured by a water immersion technique in accordance with ASTM Standard B 311. Elastic properties may be measured by an ultrasonic pulse echo technique following ASTM Standard D 2845. Hardness may be measured on the Vickers scale with a 2 kg load per ASTM Standard E 92. Flexural strength may be determined by a four-point bending test according to the MIL-STD-1942A. A flexural strength test according to ASTM Procedure No. D790 may also be used.

Fracture toughness may be measured using a four-point-bend-chevron-notch technique and a screw-driven Sintech model CITS-2000 universal testing machine under displacement control at a crosshead speed of 1 mm/min. For example, specimens measuring 6×4.8×50 mm may be tested with the loading direction parallel to the 6 mm dimension and with inner and outer loading spans of 20 and 40 mm, respectively. The chevron notch, cut with a 0.3 mm wide diamond blade, has an included angle of 60° and is located at the midlength of each specimen. The dimensions of the specimen may be chosen to minimize analytical differences between two calculation methods according to the analyses of Munz et al. (D. G. Munz, J. L. Shannon, and R. T. Bubsey, “Fracture Toughness Calculation from Maximum Load in Four Point Bend Tests of Chevron Notch Specimens,” Int. J. Fracture, 16 R137-41 (1980)).

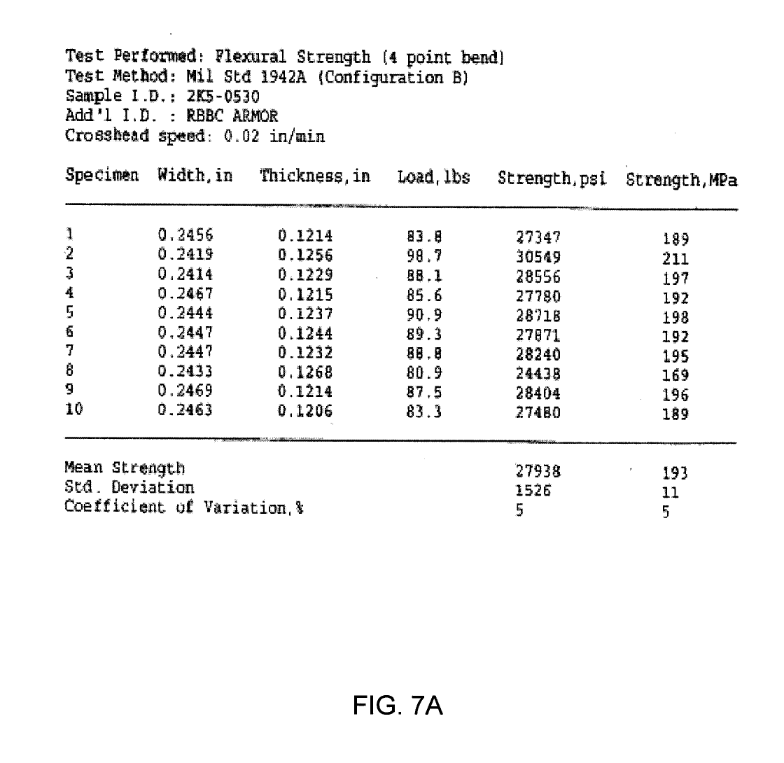

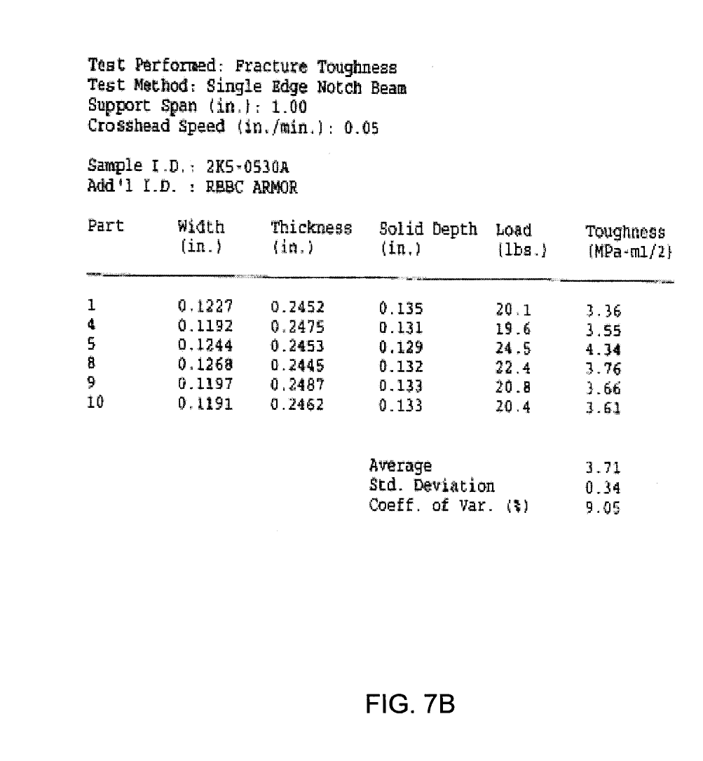

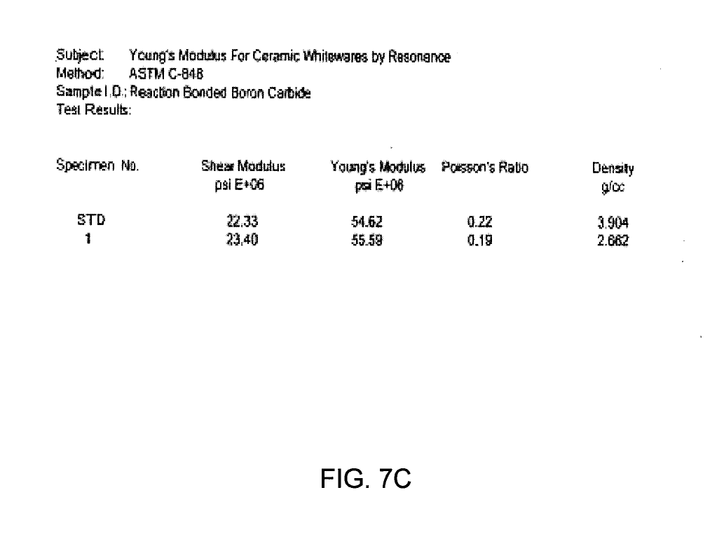

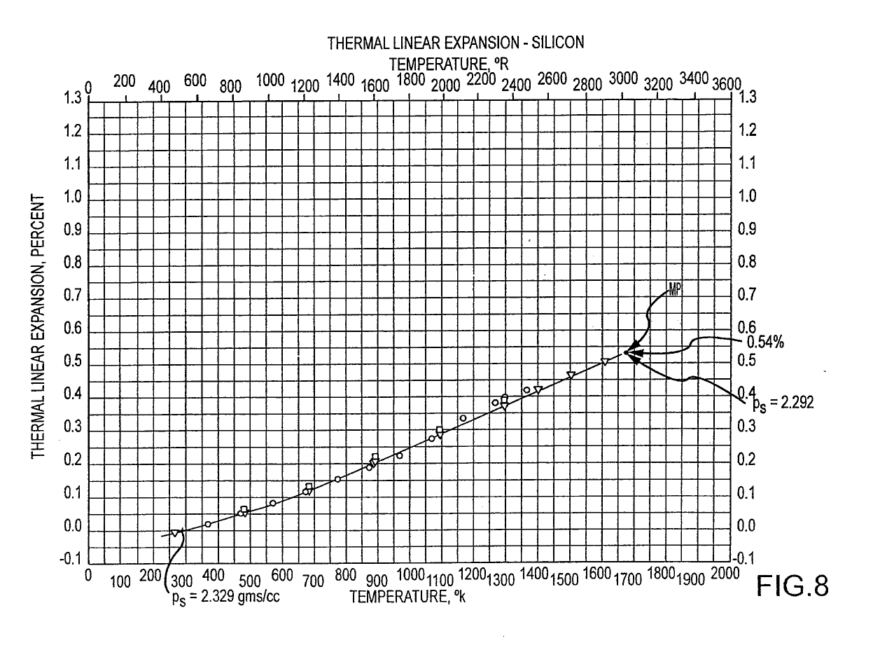

FIGS. 7A-C show data on the physical properties of some RBBC ceramic bodies. FIG. 7A lists flexural strength data for RBBC samples made according to embodiments of the invention. FIG. 7B list fracture toughness data for some of the same samples. FIG. 7C lists Young's Modulus and density data for a sample.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method of making a reaction bonded ceramic material, the method comprising:
forming a green body from a mixture of boron carbide, carbon, and an organic binder;
contacting the green body with a infiltrant comprising silicon and boron, wherein a concentration of the boron in the infiltrant is not so high to prevent reaction between the silicon in the infiltrant and the boron carbide in the green body, and wherein the infiltrant has a temperature of about 1625° C. to about 1700° C.; and
dissolving a portion of the boron carbide in the silicon and boron infiltrant to form a liquid silicon and boron solution, wherein at least a portion of the dissolved boron carbide reacts with the silicon and boron infiltrant in the solution, and wherein the solution precipitates needle-shaped structures of silicon carbide when cooled.

2. The method of claim 1, wherein the infiltrant contacts the green body in a low-pressure atmosphere having a pressure of about 100 mTorr or less.

3. The method of claim 1, wherein the green body comprises:
80% to 90%, by weight, boron carbide;
10% to 20%, by weight, free carbon.

4. The method of claim 3, wherein the free carbon comprises an organic binder.

5. The method of claim 3, wherein the free carbon comprises graphite.

6. A method of making a reaction bonded boron carbide ceramic body, the method comprising:
forming a green body from a mixture of boron carbide, carbon, and an organic binder, wherein the weight ratio of boron carbide to carbon in the green body is about 5:5 to 1 or more;
siliconizing a first portion of the boron carbide to siliconized boron carbide by contacting the green body with a silicon and boron infiltrant, wherein a concentration of the boron in the infiltrant is not so high to prevent reaction between the silicon in the infiltrant and the boron carbide in the green body, and wherein the infiltrant has a temperature of about 1625° C. to about 1700° C.; and
dissolving a second portion of the boron carbide in the silicon and boron infiltrant to form a liquid silicon and boron solution, wherein at least some of the dissolved boron carbide reacts with the silicon and boron infiltrant in the solution, and wherein the solution precipitates needle-shaped structures of silicon carbide when cooled.

7. The method of claim 6, wherein the siliconzed boron carbide comprises B₁₂C₂Si, wherein a silicon atom replaces one of the carbon atoms in the carbon backbone of the boron carbide.

8. The method of claim 7, wherein the silicon atom replaces a middle carbon atom in the carbon backbone.

9. The method of claim 6, wherein the siliconzed boron carbide comprises B₁₂CSi₂, wherein two silicon atoms replace two carbon atoms in the carbon backbone of boron carbide.

10. The method of claim 6, wherein the smooth particulates of reprecipitated boron carbide lack a sharp edge.

11. The method of claim 6, wherein the smooth particulates of reprecipitated boron carbide are substantially spherical.

12. The method of claim 6, wherein the green body comprises about 85%, by wt., boron carbide and about 15%, by wt., carbon.

13. The method of claim 6, wherein the reaction bonded boron carbide ceramic body comprises less than 10%, by wt., unsiliconized boron carbide.

14. The method of claim 6, wherein the reaction bonded boron carbide ceramic body comprises more than 10%, by wt., silicon.

15. The method of claim 6, wherein the reaction bonded boron carbide ceramic body comprises more than 20%, by wt., silicon carbide.

16. The method of claim 15, wherein at least a portion of the silicon carbide is β-SiC.

17. The method of claim 6, wherein the reaction bonded boron carbide ceramic body comprises:
about 9.3%, by wt., unsiliconized boron carbide;
about 22.5%, by wt., silicon carbide; and
about 10.9%, by wt., silicon metal.

18. The method of claim 1, wherein the boron in the infiltrant comes from elemental boron or boron carbide.

19. The method of claim 6, wherein the boron in the infiltrant comes from elemental boron or boron carbide.
